(19) United States
(12) Patent Application Publication
(10) Pub. No.: US 2022/0311044 A1
(43) Pub. Date: Sep. 29, 2022

(54) METHOD OF MAKING COMPOSITE POLYMER ELECTROLYTE FOR ALL SOLID-STATE LITHIUM-ION BATTERY

(71) Applicant: HYZON MOTORS INC., Honeoye Falls, NY (US)

(72) Inventors: Rajesh Bashyam, Delta (CA); Zhijun Gu, Jingang Town (CN); Joselito Venturina, NEW WESTMINSTER (CA); Xi Chen, Naperville, IL (US); Sai Nitin Yellamilli, Naperville, IL (US)

(21) Appl. No.: 17/706,754

(22) Filed: Mar. 29, 2022

Related U.S. Application Data
(60) Provisional application No. 63/249,066, filed on Sep. 28, 2021.
(60) Provisional application No. 63/167,173, filed on Mar. 29, 2021.

(51) Int. Cl. H01M 10/056; H01M 10/0525

(52) U.S. Cl. CPC H01M 10/056; H01M 10/0525; H01M 2300/0094; H01M 2300/0071; H01M 2300/0082

(57) ABSTRACT

Making a composite solid polymer electrolyte includes mixing a slurry of lithiated ionomer and a doped inorganic ceramic electrolyte and coating the slurry onto a lithiated ionomer membrane. The lithiated ionomer can be provided by exchanging protons of an ionomer membrane with lithium ions to form a lithiated ionomer membrane and dissolving the lithiated ionomer membrane to produce the lithiated ionomer. Various composite solid polymer electrolytes can be made for use in solid-state lithium-ion batteries. Ways of making a dispersion for use in a solid-state electrolyte include lithiating an ionomer by heating and dissoluting to form the dispersion. An ionic liquid and ceramic particles can be added to the dispersion. Ways of making a reinforced solid-state electrolyte for a solid-state lithium-ion battery include infusing a porous membrane with the dispersion.

### CROSS-REFERENCE TO RELATED APPLICATIONS

This application claims the benefit of U.S. Provisional Application No. 63/249,066, filed on Sep. 28, 2021, and U.S. Provisional Application No. 63/167,173, filed on Mar. 29, 2021. The entire disclosures of the above applications are hereby incorporated herein by reference.

### FIELD

The present technology includes processes and articles of manufacture that relate to solid-state lithium-ion batteries, including all solid-state lithium-ion batteries having a composite polymer electrolyte and/or a reinforced solid-state electrolyte.

### INTRODUCTION

This section provides background information related to the present disclosure which is not necessarily prior art.

Rechargeable lithium-ion batteries provide certain advantages, as lithium is the lightest and most electropositive element, which are properties that are important for high energy density. Advantages of lithium-ion batteries include a long shelf life, long cycle life, and the ability to store more energy than lead-acid, nickel-cadmium, and nickel metal hydride batteries. Because of these properties, there is a significant interest centered on optimizing use of lithium-ion batteries in certain applications, including hybrid, plug-in hybrid, and all-electric vehicle applications. Lithium-ion batteries are also used in other applications, such as various portable electronic devices (e.g., cell phones).

Certain lithium-ion batteries use organic liquid electrolytes, which may be based on alkyl carbonates. Organic liquid electrolytes can provide a wide electrochemical window, good ionic conductivity, and chemical stability. However, organic liquid electrolytes can also be volatile, flammable, and certain liquid electrolytes can produce toxic compounds (e.g., hydrofluoric acid) when exposed to water. Lithium-ion batteries having such electrolytes can therefore present issues when employed in certain conditions.

Certain lithium-ion batteries can also exhibit dendritic growth of Li metal onto graphite negative electrodes, which has the potential to produce an internal short circuit. In particular, lithium dendrites can extend and can accumulate over time, pierce a separator within the battery, and cause a short circuit that can result in undesired thermal events, including battery failure. Ways to minimize lithium dendrite formation and/or growth are therefore of interest in the manufacture of lithium-ion batteries.

All solid-state batteries (ASSB) are gaining significant attention in lithium-ion battery development due to several advantages, including consistent operation, high energy density, and faster charging properties. However, certain challenges remain to be overcome, especially with respect to solid-state electrolytes (SSE), in order to improve ionic conductivity and suppress formation of lithium dendrites and manufacturing solid electrolytes at high volume. Two main approaches are being employed in development of solid electrolytes, the first being the use inorganic ceramic solid electrolytes and the second being use of a solid polymer electrolyte, where both approaches have their own advantages and disadvantages.

Currently, polymer electrolytes are mainly based on lithium salt incorporated poly(ethylene oxide) (PEO), poly(acrylonitrile) (PAN), poly(vinylidene fluoride) (PVDF), and other polymers. These are generally dual ion conductors, because of both cation and anion mobility in the polymer matrix, which results in a lower Li ion transference number (e.g., 0.5). Another effect of using such polymer electrolytes can be an electroreduction of Li ions and thereby dendrite generation which can lead to a short circuit by penetration of the solid polymer electrolytes. Inorganic solid electrolytes are mostly single ion conductors; however, they generally suffer from lower ionic conductivity that also results in electroreduction of Li ions and dendrite formation. Other concerns with inorganic solid electrolytes include manufacturability and mechanical stability issues.

Accordingly, there is a need for a solid-state battery that does not contain liquid electrolyte and does not form metallic lithium dendrites.

### SUMMARY

In concordance with the instant disclosure, the present technology includes articles of manufacture, systems, and processes that relate to solid-state lithium-ion batteries having composite polymer electrolytes and to solid-state lithium-ion batteries that include a reinforced solid-state electrolyte (SSE).

Ways of making and using composite solid polymer electrolytes for a solid-state lithium-ion battery are provided. A slurry of a lithiated ionomer and a doped inorganic ceramic electrolyte can be formed and coated onto a lithiated ionomer membrane to produce a composite solid polymer electrolyte. The lithiated ionomer can be provided by exchanging protons of an ionomer membrane with lithium ions (e.g., using lithium hydroxide) to form a lithiated ionomer membrane and dissolving the lithiated ionomer membrane to produce the lithiated ionomer. Dissolving the lithiated ionomer membrane to produce the lithiated ionomer can include dissolving the lithiated ionomer membrane using N-methyl pyrrolidone. The doped inorganic ceramic electrolyte can include lithium lanthanum zirconium oxide (LLZO) doped with one of Al, Nb, and Ta. Mixing the lithiated ionomer and the doped inorganic ceramic electrolyte to form the slurry can include homogenization and high pressure mixing to provide a particle size from about 0.1 microns to about 0.3 microns. Various composite solid polymer electrolytes for use in solid-state lithium-ion batteries can be made according to the present technology. Likewise, various solid-state lithium-ion batteries can include or be manufactured using the composite solid polymer electrolyte provided by the present technology.

Ways of making and using reinforced electrolytes for use in all solid-state batteries, including lithium-ion batteries, where the reinforced electrolytes are chemically, electrochemically, and mechanically stable, are provided. To provide a solid-state electrolyte, an ionomer can be lithiated and heated to dissolute the lithiated ionomer into a dispersion for use as the solid-state electrolyte. A reinforced solid-state electrolyte for a solid-state lithium-ion battery can be provided by infusing a porous membrane with the dispersion. Certain embodiments include a reinforced solid-state electrolyte for a solid-state lithium-ion battery, where the reinforced solid-state electrolyte includes a porous membrane, ceramic particles, and a dispersion. The ceramic particles can form a coating on the porous membrane and the dispersion of a dissoluted lithiated ionomer can be infused into the porous membrane and the coating. The ceramic particles also form a coating on the porous membrane and can be infused into the porous membrane. A dispersion of a dissoluted lithiated ionomer can be infused into the porous membrane and the coating. The dispersion can further include an ionic liquid. In this way, various reinforced solid-state electrolytes for can be made for various solid-state lithium-ion batteries. Such solid-state lithium-ion batteries can include the composite and/or reinforced solid-state electrolytes made according to the present technology. All solid-state batteries constructed in accordance with the present disclosure can be used as a power source in various applications, including electric vehicles and various electronic devices.

The present technology presents significant advantages, where a lithiated electrolyte/dispersion and its resulting composite can be impregnated into substrate, such as a reinforced and expanded polytetrafluoroethylene (PTFE) substrate, and/or other porous substrates, such as cellulose, poly(ethylene oxide) (PEO), and/or poly(propylene oxide) (PPO) substrates, which result in all solid state, thinner, and more stable electrolytes compared to the current solutions. Likewise, reinforced solid-state electrolytes can be manufactured at scale with higher conductivity and stability. Manufacture of the composite solid polymer electrolytes and/or reinforced solid polymer electrolytes can include using various layer-by-layer and/or roll-to-roll techniques, thereby allowing the use of high throughput production methods. In this way, various solid-state lithium-ion batteries can include or be manufactured using the composite and/or reinforced solid-state electrolytes provided by the present technology.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is process flow schematic of an embodiment of making a dispersion for use in making a reinforced solid-state electrolyte for use in a solid-state lithium-ion battery, in accordance with the present technology.

FIG. 2 is a process flow schematic of an embodiment of making a reinforced solid-state electrolyte using the dispersion formed in FIG. 1, where the reinforced solid-state electrolyte can be used in making a solid-state lithium-ion battery, in accordance with the present technology.

FIGS. 3A, 3B, and 3C are representational formulae of lithiated ionomers useful in embodiments of the process flows shown in FIGS. 1-2, in accordance with the present technology.

FIG. 4 is a graphical representation of ionic conductivity for a solid-state lithium-ion battery including a composite lithiated perfluorosulfonic acid membrane and a solid-state lithium-ion battery including a non-composite lithiated perfluorosulfonic acid membrane.

FIG. 5 is a graphical representation of cell cycling rate performance of a solid-state lithium-ion battery including a composite lithiated perfluorosulfonic acid membrane and a solid-state lithium-ion battery including a non-composite lithiated perfluorosulfonic acid membrane.

FIG. 6 is a graphical representation of rate capability of a solid-state lithium-ion battery including a composite lithiated perfluorosulfonic acid membrane.

FIG. 7 is a graphical representation of impedance evolution of a solid-state lithium-ion battery including a composite lithiated perfluorosulfonic acid membrane.

FIG. 8 is a graphical representation of cell cycling rate performance of a solid-state lithium-ion battery including a composite lithiated perfluorosulfonic acid membrane using a lithium iron phosphate (LFP) cathode and a solid-state lithium-ion battery including a composite lithiated perfluorosulfonic acid membrane using a nickel manganese cobalt oxides (NMC) cathode.

FIG. 9 is a graphical representation of cell cycling rate performance of a solid-state lithium-ion battery including a reinforced lithiated perfluorosulfonic acid membrane and a solid-state lithium-ion battery including a reinforced composite lithiated perfluorosulfonic acid membrane.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology is drawn to composite and/or reinforced solid polymer electrolytes for use in solid-state lithium-ion batteries. A lithiated ionomer and a doped inorganic ceramic electrolyte can be mixed to form a slurry, which can be coated onto a lithiated ionomer membrane to produce a composite solid polymer electrolyte. The lithiated ionomer can be formed by exchanging protons from an ionomer membrane with lithium ions to form a lithiated ionomer membrane, which is then dissolved to produce the lithiated ionomer. The ionomer membrane can include protonated perfluorosulfonic acid converted to a lithiated form and the lithiated ionomer membrane can be dissolved using a solvent (e.g., N-methyl pyrrolidone). The doped inorganic ceramic electrolyte can include lithium lanthanum zirconium oxide doped with one of Al, Nb, and Ta. Mixing the lithiated ionomer and the doped inorganic ceramic electrolyte to form the slurry can include homogenization and high pressure mixing to provide a particle size from about 0.1 microns to about 1 micron microns preferably between 0.1 and 0.3 micron. Coating the slurry onto the lithiated ionomer membrane can include forming a coating layer having a thickness of about 5 microns to about 15 microns. The lithiated ionomer membrane can have a thickness of about 15 microns to about 30 microns. And a solid-state lithium-ion battery can be manufactured using a composite solid polymer electrolyte made according to such methods.

Methods of making a dispersion for use in a solid-state electrolyte are provided that include lithiating an ionomer and heating the lithiated ionomer to dissolute the lithiated ionomer, thereby forming the dispersion for use in a solid-state electrolyte. The ionomer can include a sulfonated tetrafluoroethylene-based fluoropolymer-copolymer. Heating the lithiated ionomer to dissolute the lithiated ionomer into the dispersion can include heating the lithiated ionomer under a pressure greater than atmospheric pressure; for example, an autoclave can be used to provide heat and greater than atmospheric pressure. An ionic liquid can be added to the dispersion. Likewise, ceramic particles can be added to the dispersion.

A reinforced solid-state electrolyte for a solid-state lithium-ion battery can be manufactured by infusing a porous membrane with a dispersion made in accordance with the present technology. The porous membrane can include expanded polytetrafluoroethylene with thickness between 3 microns and 30 microns, preferably between 3 microns and 15 microns. And the dispersion can further include ceramic particles.

Reinforced solid-state electrolytes for solid-state lithium-ion batteries are provided that include a porous membrane, ceramic particles, and a dispersion. The ceramic particles can be disposed as one of: (1) a coating on the porous membrane and (2) a coating on the porous membrane and infused into the porous membrane. The dispersion can be a dissoluted lithiated ionomer that is infused into the porous membrane and the coating. The dispersion can further include an ionic liquid. Solid-state lithium-ion batteries can be manufactured using such reinforced solid-state electrolytes made in accordance with the present methods.

The present technology further relates to a highly conductive single ion (e.g., lithium ion) organic-inorganic polymer composite electrolytes suited for use in all solid-state batteries (ASSB). Ways of making a composite solid polymer electrolyte for a solid-state lithium-ion battery include mixing a lithiated ionomer and a doped inorganic ceramic electrolyte to form a slurry and coating the slurry onto a lithiated membrane to produce the composite solid polymer electrolyte. Various composite solid polymer electrolytes for use in solid-state lithium-ion batteries can be made according to the present technology. Likewise, various solid-state lithium-ion batteries can include or be manufactured using the composite solid polymer electrolyte provided by the present technology.

A first embodiment of the present technology can include the following aspects, as defined in steps 1-5, where one of ordinary skill in the art can include suitable alterations and variations based on the guidance provided therein. Step 1: Lithium-ion exchange from protonated perfluorosulfonic acid (PFSA) membrane with equivalent weight between 700 and 1,100 g/mol, and preferably between 730 and 900 g/mol, by immersing in 1 mol/L in LiOH between 6 and 12 hours at 80° C. The lithium-ion exchanged membrane was rinsed in deionized water (DI-H₂O) followed by immersion in DI-H₂O at 80° C. for 12 hours to remove residual lithium from the membrane. The lithiated membrane was further dried at 80° C. in vacuum for 8 h. The thickness of the membrane can be from 15 to 50 microns, and preferably from 15 to 20 microns. Step 2: The lithiated membrane was dissolved in N-methyl pyrolidone at 80° C. (with lithiated membrane concentration from 5 wt % to 20 wt %) to produce lithiated ionomer. Step 3: Inorganic ceramic electrolyte with doped lithium lanthanum zirconium oxide (LLZO) mixed with lithiated ionomer in a concentration from 5 wt % to 30 wt %. The dopant in LLZO can be Al, Nb, Ta. The lithiated organic ionomer and LLZO mixture was homogenized uniformly with overhead mixture followed by high pressure mixture to a particle size from 0.1 to 0.3 micron. Step 4: The composite ionomer from Step 3 is coated by slot-die or micro gravure or spray coated onto the lithiated membrane from Step 1 to produce a composite solid polymer electrolyte that is dried at 80° C. to 100° C. in air. A thickness of the coated layer can be from 5 to 15 microns. The overall thickness of the composite membrane can be from 15 to 50 microns, and preferably from 15 to 30 microns. Step 5: The dried composite membrane from Step 4 can be transferred to a glove box, which is equipment to handle sensitive materials in air/O₂ and moisture free environment, and the membrane can be immersed in a 1:1 ethylene carbonate:propylene carbonate mixture or ethylene carbonate:ethyl methyl carbonate or ethylene carbonate:diethyl carbonate with or without addition of additives such as fluoroethylene carbonate (from 1% to 25% FEC) or vinylene carbonate (0.1 to 10%) from 1 hour to 6 hours, where and the excess solvent is removed using nonwovens, which are fabric or filter paper like materials that absorbs the solvents on the surface.

A second embodiment of the present technology can include the following aspects, as defined in steps 1-3, where one of ordinary skill in the art can include suitable alterations and variations based on the guidance provided therein. Step 1: Lithiated composite (lithium exchanged ionomer+inorganic ceramics) ionomer from Example 1 (Step 3) coated in slot-die or micro-gravure or spray coating on protonated PFSA membrane (Equiv. weight from 700-1100 g/mol; preferably from 730-900 g/mol). The membrane can be preferably a reinforced membrane. Step 2: The proton form of composite membrane can be exchanged with Li ion in 1 mol/L of LiOH from 6 to 12 hours at 80° C. The lithium ion exchanged membrane can be rinsed in DI-H₂O followed by immersion in DI-H₂O at 80° C. for 12 hours to remove residual lithium from the membrane. The lithiated membrane can be further dried at 80° C. in vacuum for 8 h. The thickness of the membrane can be from 15 to 50 microns, preferably from 15 to 20 microns. Step 3: The dried composite membrane from Step 2 can be transferred to a glove box and the membrane can be immersed in a 1:1 ethylene carbonate:propylene carbonate mixture from 1 hour to 6 hours and the excess solvent can be removed using nonwovens.

A third embodiment of the present technology can include the following aspects, where one of ordinary skill in the art can include suitable alterations and variations based on the guidance provided therein. A cathode ink slurry can be made using an electrode material such as lithium iron phosphate (LFP), nickel manganese cobalt (NMC), nickel cobalt aluminum (NCA), and/or other high voltage cathode material with the composite ionomer from the first embodiment described above (Step 3) and a carbon material, such as acetylene black, as electronically conductive additives. The slurry can be dispersed by overhead mixture for 1 hour followed by high shear mixture for 1 hour before being homogenized using a high-pressure homogenizer.

A fourth embodiment of the present technology can include the following aspects, where one of ordinary skill in the art can include suitable alterations and variations based on the guidance provided therein. The cathode ink slurry from the third embodiment was coated on aluminum foil. Alternatively, the cathode ink slurry can be directly coated on the composite membrane from the first embodiment (Step 4). Alternatively, the cathode ink slurry can be directly coated on the composite membrane of the second embodiment (Step 1) and then exchanged with lithium ion using 1 mol/L of LiOH from 6 to 12 hours at 80° C. The lithium ion exchanged membrane can be rinsed in DI-H₂O followed by immersion in DI-H₂O at 80° C. for 12 hours to remove residual lithium from the cathode electrode coated membrane.

A fifth embodiment of the present technology can include the following aspects, where one of ordinary skill in the art can include suitable alterations and variations based on the guidance provided therein. The cathode electrode coated membrane from the fourth embodiment is transferred to glove box and the membrane immersed in a 1:1 ethylene carbonate:propylene carbonate mixture from 1 hour to 6 hours and the excess solvent can be removed using nonwovens. Both a composite membrane and a cathode electrode coated membrane can be used to make coin cell or pouch cell batteries inside a glove box for testing with Li metal foil as an anode, copper as a current collector on the anode, and aluminum as a current collector on the cathode. In certain embodiments, anode free cell (Li metal foil free) can also be made and optimized for performance and cycling durability.

The present technology further relates to reinforced solid-state electrolytes, including ways of making and using dispersions to form reinforced solid-state electrolytes, as well as solid-state lithium-ion batteries including such solid-state electrolytes. Methods of making a dispersion for use in a solid-state electrolyte are provided that include lithiating an ionomer and heating the lithiated ionomer to dissolute the lithiated ionomer into the dispersion for use in a solid-state electrolyte. The ionomer can include a sulfonated tetrafluoroethylene-based fluoropolymer-copolymer. Heating the lithiated ionomer to dissolute the lithiated ionomer into the dispersion can include heating the lithiated ionomer under a pressure greater than atmospheric pressure; e.g., by use of an autoclave. An ionic liquid and/or ceramic particles can be added to the dispersion.

Certain embodiments include various ways of making lithiated dispersions and lithiated composite dispersions. The lithiated dispersion can be mixed with the inorganic ceramic oxides in different ratios. The dispersion can include an alcohol (e.g., isopropyl alcohol) as a primary solvent with a mixture of water, other solvents, and/or alcohols as secondary solvents (e.g., n-propyl alcohol and water). Protonated ionomer powder, such as a sulfonated tetrafluoroethylene-based fluoropolymer-copolymer (e.g., perfluorosulfonic acid) or ionomer membrane (e.g., Nafion™) in a primary solvent (e.g., isopropanol) or primary and secondary solvent mixtures (e.g., n-propyl alcohol and water) can be heated in an autoclave or under 80° C. under atmospheric conditions and then lithiated using a stoichiometric amount of lithium hydroxide under neutral pH. One or more inorganic ceramic oxides, such as lithium lanthanum zirconium oxide (LLZO) with different dopants, can be added and mixed at high shear to reduce the particle size to between 0.1 to 3 microns. In certain cases, N-methyl-2-pyrrolidone (NMP) can be added to the lithiated ionomer solution in different ratios, preferably between 1% to 90%.

Manufacture of reinforced solid-state electrolytes can employ various interchangeable steps, components, and operations. In one embodiment, a porous membrane can be infused with a dispersion made according to the present technology. The porous membrane can include expanded polytetrafluoroethylene. The dispersion can further include ceramic particles. In another embodiment, a reinforced solid-state electrolyte is provided that includes a porous membrane, ceramic particles forming a coating on the porous membrane, and a dispersion of a dissoluted lithiated ionomer infused into the porous membrane and the coating. In yet another embodiment, a reinforced solid-state electrolyte is provided that includes a porous membrane, ceramic particles forming a coating on the porous membrane and further infused into the porous membrane, and a dispersion of a dissoluted lithiated ionomer infused into the porous membrane and the coating. In certain embodiments, the dispersion can further include an ionic liquid.

Various reinforced solid-state electrolytes can be made in accordance with the present technology. Such electrolytes can be used in manufacture of various solid-state lithium-ion batteries in accordance with the present technology. Various solid-state lithium-ion batteries made in accordance with the present technology can be used as power sources in various applications, including electric vehicles and electronic devices.

The present technology further contemplates making a reinforced composite solid polymer electrolyte for a solid-state lithium-ion battery by mixing a lithiated ionomer and a doped inorganic ceramic solid-state electrolyte to form a slurry and coating the lithiated dispersion or lithiated composite dispersion. The lithiated ionomer can be made using either protonated powder or a protonated dispersion. The equivalent weight of the ionomer polymer can be between 730 g and 1100 g. The lithiation can be performed using lithium hydroxide or lithium nitrate, for example. The lithiation and dissolution can be performed using an autoclave at predetermined temperature and pressure values.

Various composite solid polymer electrolytes for use in solid-state lithium-ion batteries can be made according to the present technology. Certain embodiments include inorganic ceramic electrolyte with doped lithium lanthanum zirconium oxide (LLZO) mixed with lithiated ionomer in a concentration from 5 wt % to 30 wt %. The dopant in LLZO can include Al, Nb, Ta. The lithiated organic ionomer and LLZO mixture can be homogenized uniformly by overhead mixing followed by a high pressure mixing to produce a particle size from about 0.1 to 0.3 micron.

Various solid-state lithium ion batteries can include or be manufactured using the composite solid polymer electrolyte, in accordance with the present technology. The composite ionomer can be coated by slot-die or micro gravure or spray coated onto various porous substrates, such as expanded polytetrafluoroethylene (ePTFE), to produce a reinforced all solid-state lithium composite solid polymer electrolyte that can be dried at 80° C. to 100° C. in air. A thickness of the coated layer can be from about 5 to 50 microns, and in certain embodiments can be about 15 microns. The overall thickness of the composite membrane can be from about 15 to 70 microns, and preferably from about 15 to 30 microns. The dried composite electrolyte can be transferred to a glove box, which includes equipment to handle sensitive materials in air/O₂ and provide a moisture free environment, and the membrane can be immersed in a 1:1 ethylene carbonate:propylene carbonate mixture from about 1 to 6 hours, where the excess solvent can be removed using nonwovens (e.g., fabric or filter paper-like materials that absorb solvents from the surface).

Certain embodiments of the present technology can include the following aspects. Lithiated ionic liquid can be added in the dispersion of lithiated ionomer and/or lithiated ionomer/ceramic oxide composite and can be infiltrated or infused into the porous substrate. The dispersion formed with ionic liquids can be coated as a separate layer. The ceramic solid-state electrolyte (SSE) can include a garnet material, such as lithium lanthanum zirconium oxide (LLZO), and which can include lithium aluminum titanium phosphate (LATP), lithium lanthanum titanate (LLTO), lithium phosphorous sulfide (LPS), lithium germanium phosphorous sulfide (LGPS), etc. Various reinforced solid polymer electrolytes for use in solid-state lithium-ion batteries can be manufactured. Likewise, various solid-state lithium-ion batteries can include or be manufactured using the reinforced solid polymer electrolyte provided by the present technology.

The present technology can provide certain benefits and advantages in all lithium-ion solid state batteries, including batteries used for various portable and mobility applications such as vehicles. Several issues with respect to lithium-ion batteries are addressed by the present technology, including the suppression of formation of lithium metal dendrites, higher conductivity, where the present batteries can provide more consistent performance and cycling durability. All solid-state batteries as manufactured and provided herein can attain a higher capacity than other such batteries and are suitable for operation in expanded environments, including environments where batteries fabricated using volatile, flammable, liquid electrolytes would impose certain limitations or be undesirable.

### EXAMPLES

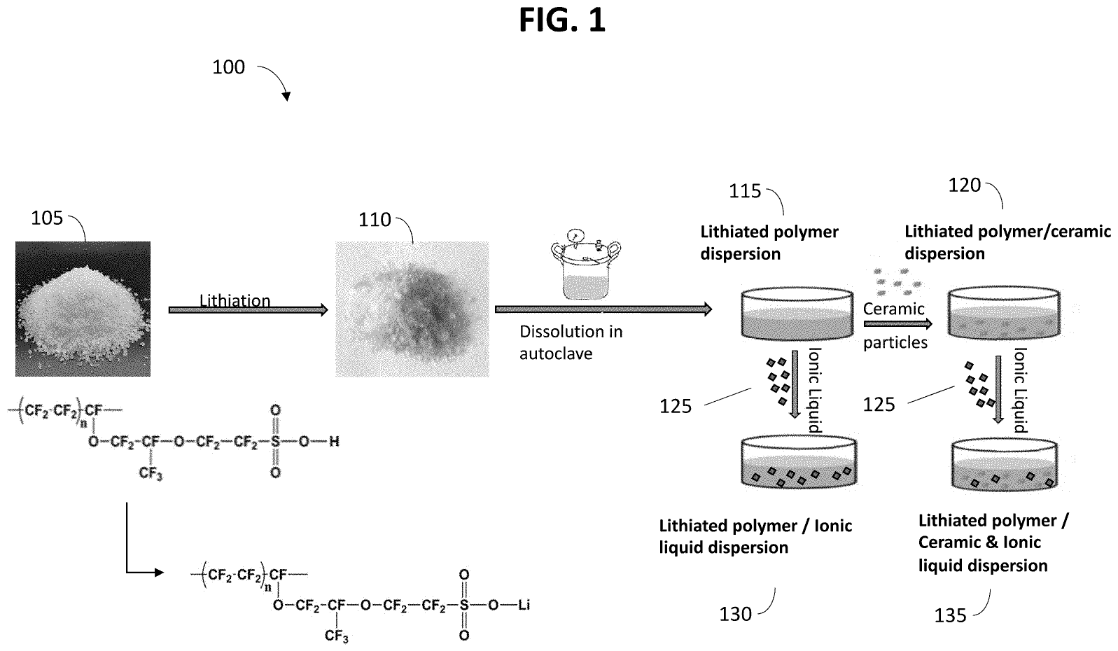

Example embodiments of the present technology are provided with reference to FIGS. 1-10 enclosed herewith.

With reference to FIG. 1, shown at 100 is a process flow schematic of an embodiment of making a dispersion for use in making a reinforced solid-state electrolyte for use in a solid-state lithium-ion battery. In the example depicted, an ionomer 105 (e.g., perfluorosulfonic acid resin) is lithiated to exchange protons for lithium to form a lithiated ionomer 110. The lithiated ionomer 110 is subjected to dissolution under heat/pressure (e.g., autoclave) to form a dispersion 115 of the lithiated ionomer 110. Ceramic particles 120 can optionally be added to the dispersion 115 of the lithiated ionomer 110. An ionic liquid 125 is combined with the lithiated polymer dispersion itself, as shown at 130, or with the further addition of ceramic particles, as shown at 135.

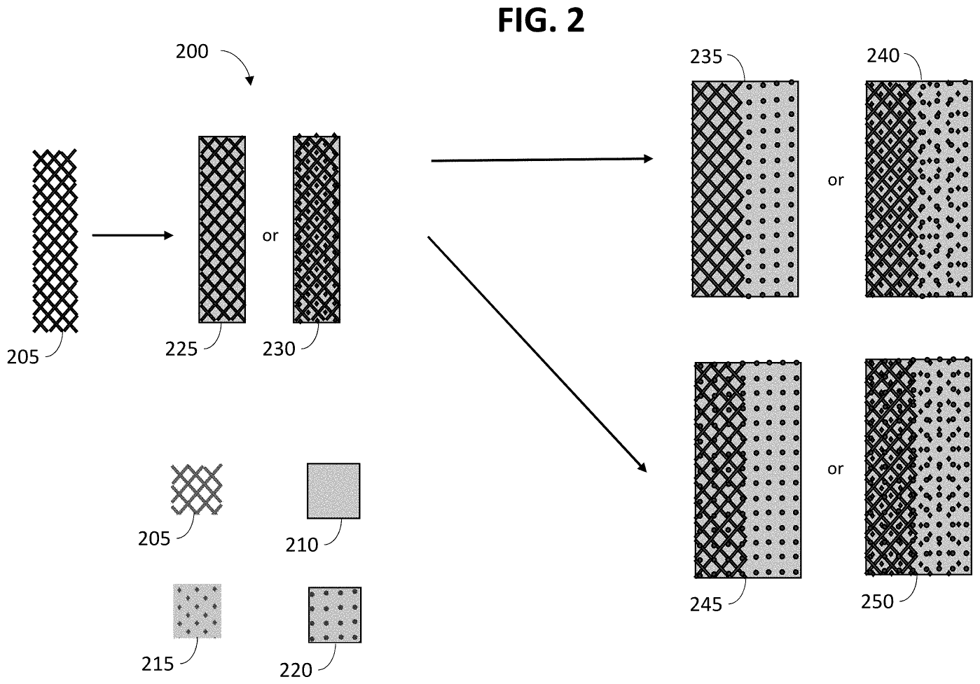

With reference to FIG. 2, shown at 200 is a process flow schematic of embodiments of making reinforced solid-state electrolytes using a dispersion, such as the dispersion formed in the process shown in FIG. 1. The reinforced solid-state electrolytes can be used in making a solid-state lithium-ion battery. Depicted are a porous membrane 205, a lithiated ionomer 210, a lithiated ionic liquid 215, and a lithiated ionomer with ceramic solid-state electrolyte (SSE) coating 220. Examples of the ceramic SSE coating 220 include garnet LLZO, LATP, LLTO, LPS, LGPS, etc. As shown at 225, the porous membrane 205 (e.g., ePTFE) is infused with the lithiated ionomer 210. Or, as shown at 230, the porous membrane 205 is infused with the lithiated ionic liquid 215. As shown at 235, the porous membrane 205 (e.g., ePTFE) can include the ceramic SSE coating 220 on a surface of thereof when infused with the lithiated ionomer 210. Likewise, as shown at 240, the porous membrane 205 can include the ceramic SSE coating 220 on a surface of thereof when infused with the lithiated ionic liquid 215. It is also possible to have the ceramic SSE coating 220 on a surface of the porous membrane 205 as well as infused within the porous membrane 205, when infused with the lithiated ionomer 210, as shown at 245. And the ceramic SSE coating 220 can be on a surface of the porous membrane 205 as well as infused within the porous membrane 205, when infused with the lithiated ionic liquid 215, as shown at 250. In this way, reinforced composite all solid-state electrolytes can be formed.

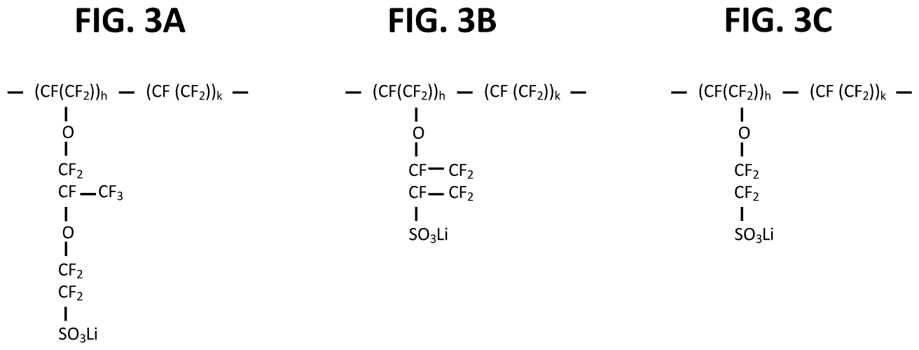

With reference to FIGS. 3A, 3B, and 3C, shown are representational formulae of lithiated ionomers useful in embodiments of the process flows shown in FIGS. 1-2. FIG. 3A shows an example of a long-side-chain (LSC) ionomer with an equivalent weight (EW) of 900-1100 g. FIG. 3B shows an example of a medium-side-chain (MSC) ionomer with an EW of 730-980 g. FIG. 3C shows an example of a short-side-chain (SSC) ionomer with an EW of 730-980 g. The lithiated ionomer with both SSC ionomer and LSC ionomer can have an SSC:LSC ratio of 0.5-2. The ceramic solid-state electrolyte (SSE):lithiated ionomer ratio can be 1%-25%.

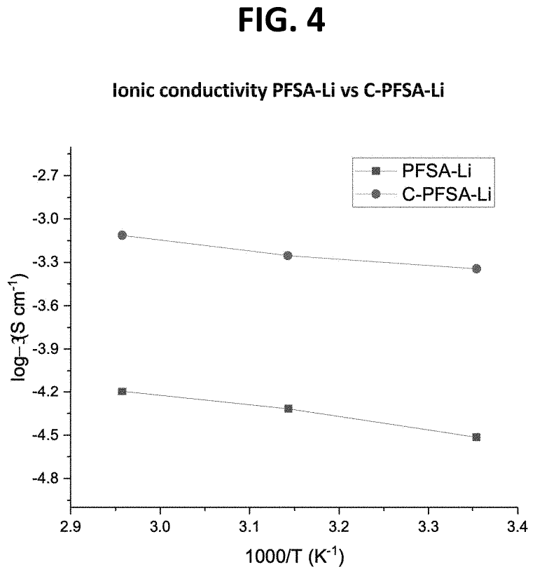

With reference to FIG. 4, shown is a graphical representation of ionic conductivity for a solid-state lithium-ion battery including a composite lithiated perfluorosulfonic acid membrane and a solid-state lithium-ion battery including a non-composite lithiated perfluorosulfonic acid membrane, where Table 1 shows the collected raw data.

TABLE 1
Ionic conductivity data for PFSA-Li and C-PFSA-Li.

| SSE Samples | Ionic Conductivity (S/cm) |
|---|---|
| PFSA-Li RT | 3.06*10⁻⁵ |
| PFSA-Li 45° C. | 4.816*10⁻⁵ |
| PFSA-Li 65° C. | 6.37*10⁻⁵ |
| C-PFSA-Li (Li) RT | 4.521*10⁻⁴ |
| C-PFSA-Li (Li) 45° C. | 5.58*10⁻⁴ |
| C-PFSA-Li (Li) 65° C. | 7.713*10⁻⁴ |

As can be seen, the composite PFSA-Li membrane showed better ionic conductivity than PFSA-Li membrane.

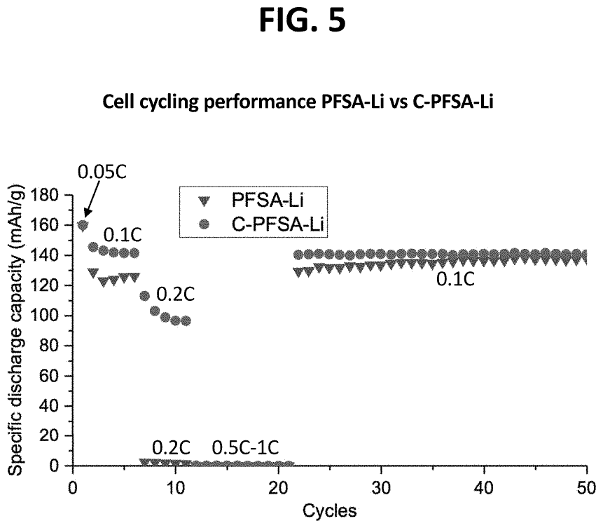

With reference to FIG. 5, shown is a graphical representation of cell cycling rate performance of a solid-state lithium-ion battery including a composite lithiated perfluorosulfonic acid membrane and a solid-state lithium-ion battery including a non-composite lithiated perfluorosulfonic acid membrane. The experimental data were obtained for cell cycling performance of PFSA-Li versus C-PFSA-Li, using LFP cathode Li metal cells, solvent swollen electrode only, where Table 2 provides the collected raw data.

TABLE 2
Cell cycling performance data for PFSA-Li and C-PFSA-Li.

Specific Discharge Capacity (mAh/g)

| | | |
|---|---|---|
| Cycles | PFSA-Li | C-PFSA-Li |

| | | | |
|---|---|---|---|
| 0.05 C | (1^{st} cycle) | 159.8 | 160.1 |
| 0.1 C | (2^{nd} cycle) | 129.0 | 145.5 |
| 0.1 C | (5^{th} cycle) | 125.8 | 141.5 |
| 0.2 C | (10^{th} cycle) | 1.7 | 96.7 |
| 0.1 C | (25^{th} cycle) | 131.9 | 140.8 |

As can be seen, the composite PFSA-Li membrane showed better rate capability conductivity than the PFSA-Li membrane.

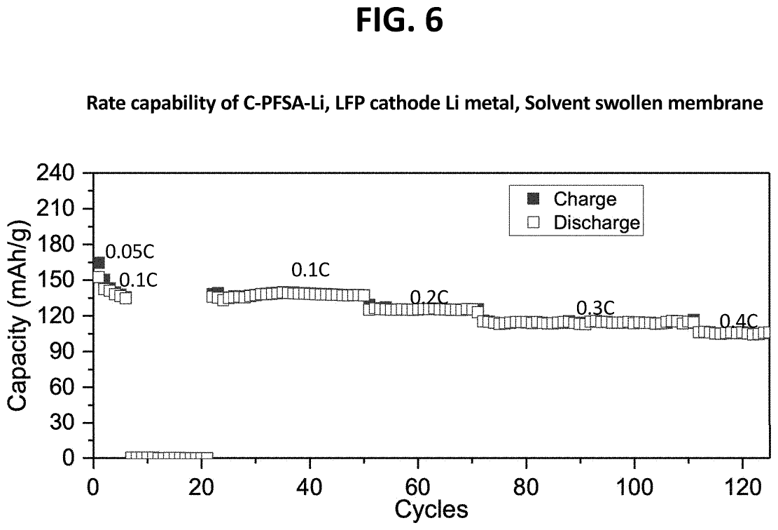

With reference to FIG. 6, shown is a graphical representation of rate capability of a solid-state lithium-ion battery including a composite lithiated perfluorosulfonic acid membrane. The data were collected for rate capability of C-PFSA-Li, LFP cathode Li metal, solvent swollen membrane. As can be seen, rate capability of C-PFSA-Li can provide stable cycling to 0.4C.

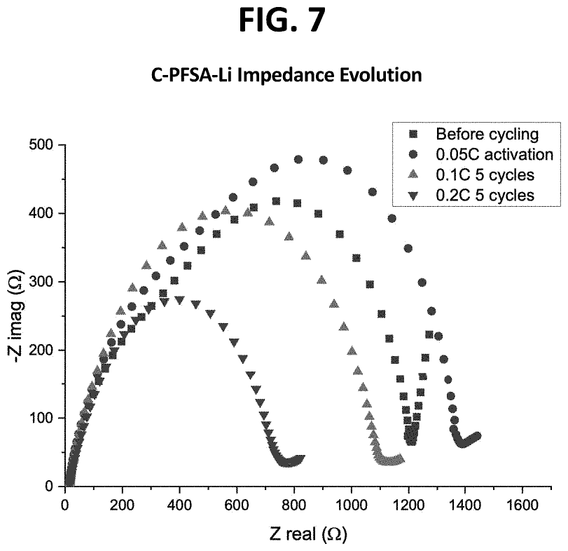

With reference to FIG. 7, shown is a graphical representation of impedance evolution of a solid-state lithium-ion battery including a composite lithiated perfluorosulfonic acid membrane. Squares represent before cycling, circles represent 0.05C activation, triangles represent 0.1C 5 cycles, and inverted triangles represent 0.2C 5 cycles. As can be seen, the composite PFSA-Li membrane LFP cathode Li metal cells showed impedance reduction.

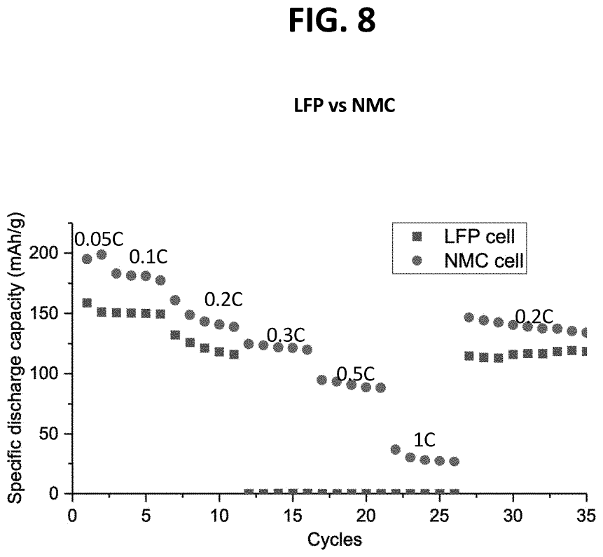

With reference to FIG. 8, shown is a graphical representation of cell cycling rate performance of a solid-state lithium-ion battery including a composite lithiated perfluorosulfonic acid membrane using a lithium iron phosphate (LFP) cathode and a solid-state lithium-ion battery including a composite lithiated perfluorosulfonic acid membrane using a nickel manganese cobalt (NMC) cathode. Composite PFSA-Li membrane were formed using LFP and NMC cathode Li metal cells, both electrode and electrolyte solvent swollen. As can be seen, in the composite PFSA-Li membrane Li metal full cell, the NMC cathode showed better rate performance than the LFP cathode.

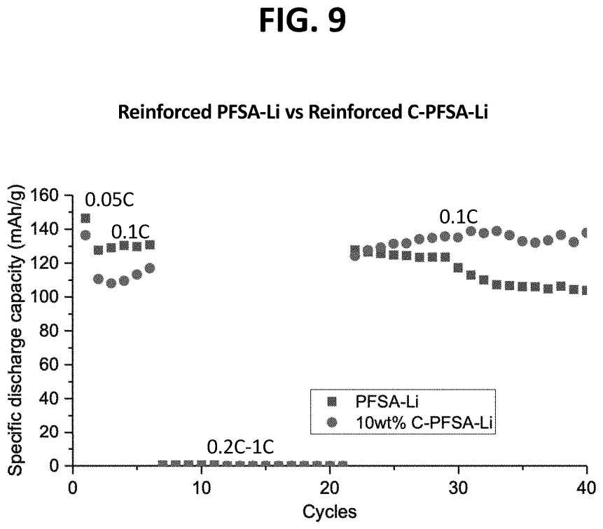

With reference to FIG. 9, shown is a graphical representation of cell cycling rate performance of a solid-state lithium-ion battery including a reinforced lithiated perfluorosulfonic acid membrane versus a solid-state lithium-ion battery including a reinforced composite lithiated perfluorosulfonic acid membrane. The reinforced PFSA-Li and the reinforced C-PFSA-Li were used in LFP cathode Li metal cells, solvent swollen both electrode and electrolyte. As can be seen, the composite PFSA-Li membrane showed better cycling capacity retention than the PFSA-Li membrane.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of making a composite solid polymer electrolyte for a solid-state lithium-ion battery, comprising:
mixing a lithiated ionomer and a doped inorganic ceramic electrolyte to form a slurry; and
coating the slurry onto a lithiated ionomer membrane to produce the composite solid polymer electrolyte.

2. The method of claim 1, wherein the lithiated ionomer is provided by:
exchanging protons of an ionomer membrane with lithium ions to form a lithiated ionomer membrane; and
dissolving the lithiated ionomer membrane to produce the lithiated ionomer.

3. The method of claim 2, wherein the ionomer membrane includes protonated perfluorosulfonic acid and dissolving the lithiated ionomer membrane to produce the lithiated ionomer includes dissolving the lithiated ionomer membrane using N-methyl pyrrolidone.

4. The method of claim 1, wherein the doped inorganic ceramic electrolyte includes lithium lanthanum zirconium oxide doped with one of Al, Nb, and Ta.

5. The method of claim 1, wherein mixing the lithiated ionomer and the doped inorganic ceramic electrolyte to form the slurry includes homogenization and high pressure mixing to provide a particle size from about 0.1 microns to about 0.3 microns.

6. The method of claim 1, wherein coating the slurry onto the lithiated ionomer membrane to produce the composite solid polymer electrolyte includes forming a coating layer having a thickness of about 5 microns to about 15 microns.

7. The method of claim 6, wherein the lithiated ionomer membrane has a thickness of about 15 microns to about 30 microns.

8. A solid-state lithium-ion battery including a composite solid polymer electrolyte made according to the method of claim 1.

9. A method of making a dispersion for use in a solid-state electrolyte, comprising:
lithiating an ionomer; and
heating the lithiated ionomer to dissolute the lithiated ionomer, thereby forming the dispersion for use in a solid-state electrolyte.

10. The method of claim 9, wherein the ionomer includes a sulfonated tetrafluoroethylene-based fluoropolymer-copolymer.

11. The method of claim 9, wherein heating the lithiated ionomer to dissolute the lithiated ionomer into the dispersion includes heating the lithiated ionomer under a pressure greater than atmospheric pressure.

12. The method of claim 11, wherein heating the lithiated ionomer under the pressure greater than atmospheric pressure includes use of an autoclave.

13. The method of claim 9, further comprising adding an ionic liquid to the dispersion.

14. The method of claim 9, further comprising adding ceramic particles to the dispersion.

15. A method of making a reinforced solid-state electrolyte for a solid-state lithium-ion battery, comprising:
infusing a porous membrane with a dispersion made according to the method of claim 9.

16. The method of claim 15, wherein the porous membrane includes expanded polytetrafluoroethylene.

17. The method of claim 15, wherein the dispersion further includes ceramic particles.

18. A reinforced solid-state electrolyte for a solid-state lithium-ion battery, comprising:
a porous membrane;
ceramic particles disposed as one of
a coating on the porous membrane, and
a coating on the porous membrane and infused into the porous membrane; and
a dispersion of a dissoluted lithiated ionomer infused into the porous membrane and the coating.

19. The reinforced solid-state electrolyte for a solid-state lithium-ion battery of claim 18, wherein the dispersion further includes an ionic liquid.

20. A solid-state lithium-ion battery including the reinforced solid-state electrolyte according to claim 18.
